(19) United States
(12) Patent Application Publication
(10) Pub. No.: US 2026/0219414 A1
(43) Pub. Date: Jul. 30, 2026

(54) DOWNHOLE ANISOTROPY INVERSION FOR LOOK AHEAD DETECTION DURING DRILLING

(71) Applicant: Halliburton Energy Services, Inc., Houston, TX (US)

(72) Inventors: Jin Ma, Houston, TX (US); Clint Lozinsky, Houston, TX (US)

(21) Appl. No.: 19/303,647

(22) Filed: Aug. 19, 2025

Related U.S. Application Data
(60) Provisional application No. 63/749,878, filed on Jan. 27, 2025.

(51) Int. Cl. G01V 3/28; E21B 7/04; E21B 7/06; E21B 44/00; E21B 47/13

(52) U.S. Cl. CPC G01V 3/28; E21B 7/06; E21B 44/00; E21B 47/13; E21B 7/046

(57) ABSTRACT

A method comprises determining an anisotropy ratio of at least one property of a subsurface formation ahead of a drill bit relative to a direction that the drill bit is drilling a wellbore in the subsurface formation. The method comprises inverting the anisotropy ratio and predicting a formation characteristic of the subsurface formation that is ahead of the drill bit based on the inverted anisotropy ratio.

### BACKGROUND

In different downhole applications (such as Logging-while-Drilling (LWD), Measurement-while-Drilling (MWD), geosteering applications, etc.) detecting incoming geological formations or structures ahead of drill bit is critical to avoiding drilling hazards caused by faults or abnormal geological structures. Proactively identifying these formations allows for adjustment of well trajectory early, optimization of drilling directions in real-time and enhancement of reservoir production.

### BRIEF DESCRIPTION OF THE DRAWINGS

Embodiments of the disclosure may be better understood by referencing the accompanying drawings.

FIG. 1 is a perspective view in partial cross sectional of a well system, according to some implementations.

FIG. 2 is a perspective view of an example downhole tool, according to some implementations.

FIGS. 3A-3C are three geographical models built to analyze the sensitivity of resistivity and anisotropy ratio ahead of the drill bit, according to some implementations.

FIG. 4 depicts graphs of component sensitivity for anisotropy ahead, according to some implementations.

FIG. 5 depicts examples of inverted anisotropy ratios ahead at different depths, according to some implementations.

FIG. 6 is a flowchart of example operations for downhole anisotropy inversion for look ahead detection during drilling, according to some implementations.

FIG. 7 is a block diagram of an example computer, according to some implementations.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description. Additionally, relative terms such as down or up within a well or wellbore may be changed and still be within example implementations. Further, spatially relative terms, such as “beneath,” “below,” “lower,” “above,” “upper,” “uphole,” “downhole,” “upstream,” “downstream,” and the like, may be used herein for ease of description to describe one element or feature's relationship to another element(s) or feature(s) as illustrated in the figures. The spatially relative terms are intended to encompass different orientations of the apparatus in use or operation in addition to the orientation depicted in the figures. For example, if the apparatus in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Example implementations relate to downhole applications in a wellbore. Some implementations relate to downhole drilling applications that may enable lookahead detection (ahead of the drill bit) to predict properties of the subsurface formation that is ahead of the drill bit. For example, some implementations may include the inversion of an anisotropy ratio to differentiate between shale or sand ahead of the drill bit. In some implementations, the anisotropy ratio may be defined as a parameter used to describe the degree of directional dependence of a physical property in a material. The anisotropy ratio may quantify how much a material's properties vary when measured along different directions. In some implementations, the anisotropy ratio may be a ratio of any property of the subsurface formation. For example, the anisotropy ratio may be a ratio of the resistivity of the subsurface formation. For instance, the anisotropy ratio may be the vertical resistivity (Rv) divided by the horizontal resistivity (Rh).

Such implementations may provide more accurate information, enabling real-time geosteering decision to optimize drilling performance and mitigate risks. Thus, example implementations may predict formation characteristics ahead of a transmitter or drill bit based on inversion of an anisotropy ratio. For example, some implementations may use anisotropy ratio predictions to distinguish between shale and sand or water-bearing formations. Example implementations may proactively distinguish between shale and sand/water formations ahead of the drill bit. Such implementations may enable the making of more precise geosteering decisions, reducing the risk of drilling hazards and improving wellbore placement. Additionally, example implementations may enhance reservoir production through optimized well trajectories, ultimately maximizing asset value.

Example implementation may be based on the application of Ultra-Deep Azimuthal Resistivity (UDAR) technology, which has been successfully deployed to identify resistivity changes ahead of the drill bit in near-vertical wells. However, recent advancements in two-dimensional (2D) and three-dimensional (3D) inversion technologies for horizontal wells have enabled horizontal look-ahead capabilities, particularly in high-angle and horizontal drilling environments.

Conventional look-around inversions are typically used to identify boundaries in vertical and lateral planes, with interpreted structures projected ahead based on assumptions of continuous boundaries. However, these conventional approaches are insufficient for detecting certain geological hazards, which require inversion techniques sensitive to formations directly ahead of the bit.

Example implementations may focus on leveraging the sensitivity of resistivity and anisotropy ratio in 3D geological models. In some implementations, using the Gauss-Newton method for inversion, the anisotropy ratio may be predicted in 3D distributions and used to distinguish between shale and sand formations ahead of the drill bit. Thus, as further described below, example implementations may use the inversion of the anisotropy ratio to predict whether the formation ahead of the drill bit is either shale or sand (water). Such implementations are different than conventional approaches that use inversion of the resistivity. However, often times, inversion of the resistivity is not able to differentiate between shale and sand (water). As further described below, example implementations use an inversion of the anisotropy ratio to differentiate between shale and sand (water). Accordingly as further described below, example implementations may provide an advanced, real-time solution for addressing geological challenges ahead of the drill bit, improving geosteering accuracy and operational safety.

### Example System

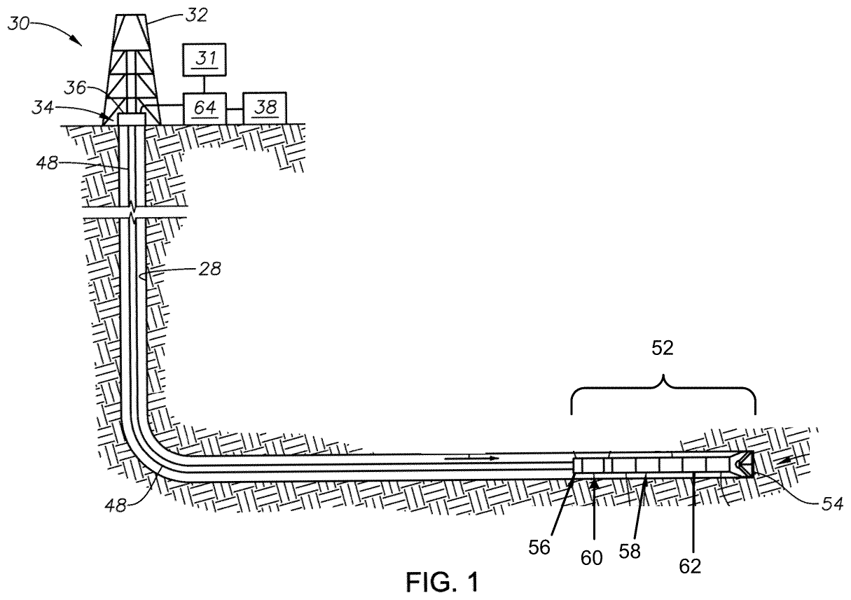

FIG. 1 is a perspective view in partial cross sectional of a well system, according to some implementations. FIG. 1 depicts a wellbore 28 that is positioned at a surface 13 of a formation 12 and is being drilled into the formation 12. A drilling system 30 is generally shown associated therewith. The drilling system 30 may include a drilling platform 32 positioned over the formation 12, and a wellhead installation 34, including blowout preventers 36. The drilling platform 32 may be disposed for raising and lowering a drill pipe 48 within the wellbore 28.

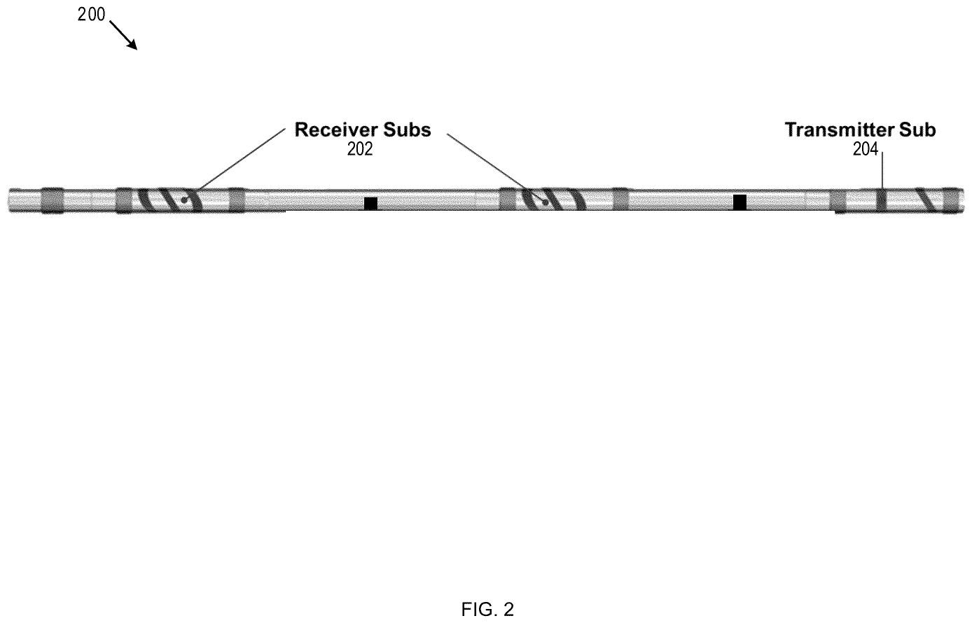

The drilling system 30 includes a drill pipe 48 and a bottom-hole-assembly (BHA) 52. The BHA may include a downhole tool 62, and a drill bit 54. An example of the downhole tool 62 is depicted in FIG. 2 (which is further described below). The BHA 52 may also include a power module 56, such as a mud motor, a steering module 58, and a control module 60. The BHA 52 illustrated in FIG. 1 may be a measurement-while-drilling or logging-while-drilling system in which geosteering of the drill bit 54 or other operation may be performed based on anisotropy inversion based on look ahead detection (as described herein). The mud motor module 56 may be driven by the drilling fluid flow, and in turn it drives the drill bit 54 to extend the wellbore 28 along a desired path. Mud motor module 56 may also provide power to the electronics, etc. of the downhole tool 62.

Steering module 58 may enable the wellbore 28 to be extended in a desired direction. Many suitable steering mechanisms are well known, e.g., steering vanes, “bent sub” assemblies, and rotary steerable systems. The steering mechanism configuration can be set and adjusted by commands from a controller either downhole and/or at the surface of the wellbore. Alternatively, the controller may be programmed with a desired route, and it can adjust the steering mechanism as needed to direct the wellbore along the desired path.

FIG. 2 is a perspective view of an example downhole tool, according to some implementations. FIG. 2 depicts a downhole tool 200 that includes a transmitter sub 202 and receiver subs 204. The transmitter sub 202 may emit electromagnetic signals that traverse the surrounding subsurface formation around the wellbore. The receiver subs 204 may receive the electromagnetic signals after their traversal through the surrounding subsurface formation. As further described below, these electromagnetic signals may be processed to determine a value of a property of the subsurface formation. For example, a horizontal resistivity (Rh) and a vertical resistivity (Rv) may be determined based on these electromagnetic signals.

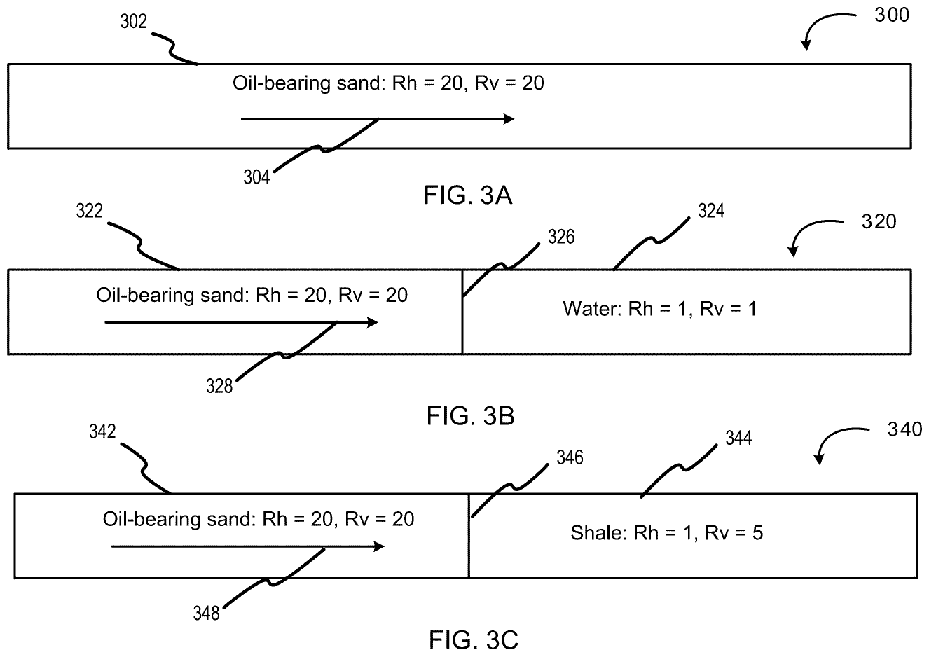

FIGS. 3A-3C are three geographical models built to analyze the sensitivity of resistivity and anisotropy ratio ahead of the drill bit, according to some implementations. FIG. 3A depicts a geographical model 300 that is a benchmark model for a formation that includes homogeneous, oil-bearing sand 302. The geographical model 300 also includes a drill bit 304 drilling through the homogeneous, oil-bearing sand 302. In this example, the Rh and the Rv of the homogeneous, oil-bearing sand 302 are both 20.

FIG. 3B depicts a geographical model 320 for a formation that includes oil-bearing sand 322 and water 324 having a boundary 326 in between. The geographical model 320 also includes a drill bit 328 drilling through the homogeneous, oil-bearing sand 302 and approaching the boundary 326. In this example, the Rh and the Rv of the homogeneous, oil-bearing sand 322 are both 20, while the Rh and the Rv of the water 324 are both 1. In this example, the anisotropy ratio may be Rv/Rh=1.

FIG. 3C depicts a geographical model 340 for a formation that includes oil-bearing sand 342 and shale 344 having a boundary 346 in between. The geographical model 320 also includes a drill bit 348 drilling through the homogeneous, oil-bearing sand 302 and approaching the boundary 326. In this example, the Rh and the Rv of the homogeneous, oil-bearing sand 322 are both 20, while the Rh and the Rv of the shale 344 are 1 and 5, respectively. In this example, the anisotropy ratio may be Rv/Rh=5. Also, in this example, the depth of the boundary 346 is 122 meters (m).

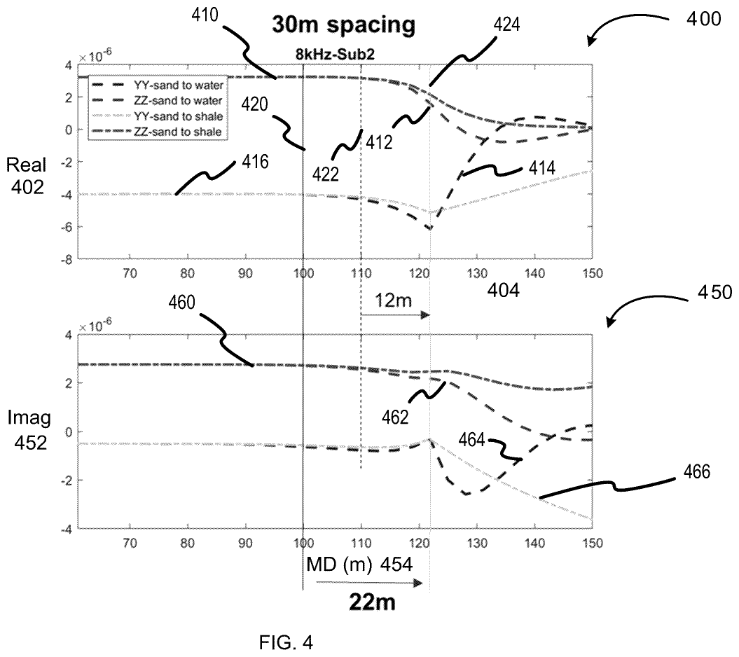

The electromagnetic signal that is detected may be a complex signal having real and imaginary parts). FIG. 4 depicts graphs of component sensitivity for anisotropy ahead, according to some implementations. FIG. 4 includes a graph 400 and a graph 450. The graph 400 includes a real component 402 of the data along the y-axis and a depth in the wellbore (a depth 404) along the x-axis. The graph 450 includes an imaginary component 452 of the data along the y-axis and a depth in the wellbore (a depth 454) along the x-axis.

The graph 400 includes four curves that tracks the real component 402 over the depth 404. A first curve 414 is a YY value showing a change from sand to water. A second curve 412 is a ZZ value showing a change from sand to water. A third curve 416 is a YY value showing a change from sand to shale. A fourth curve 410 is a ZZ value showing a change from sand to shale. The graph 450 includes four curves that tracks the imaginary component 452 over the depth 454. A first curve 464 is a YY value showing a change from sand to water. A second curve 462 is a ZZ value showing a change from sand to water. A third curve 466 is a YY value showing a change from sand to shale. A fourth curve 460 is a ZZ value showing a change from sand to shale. A line 420 is at 100 m for a first depth of the drill bit. A line 422 is at 110 m and is at a second depth of the drill bit. A line 424 is 12 m look ahead of the line 422 and is 22 m look ahead of the line 420.

As shown in the graph 400, the signal starts to change at 12 m ahead (at the line 424 relative to the line 422—to be able to differentiate. For example, as shown by the curve 414 and the curve 416 at approximately 12 m ahead, the YY value is changing to be able to differentiate between sand to water (the curve 414) and sand to shale (the curve 416). Also, as shown by the curve 410 and the curve 412 at approximately 12 m ahead, the ZZ value is changing to be able to differentiate between sand to water (the curve 412) and sand to shale (the curve 410). Accordingly, the inversion of the anisotropy ratio enables the differentiation between different composite materials ahead of the drill bit (differentiating between shale, sand, and water ahead of the drill bit).

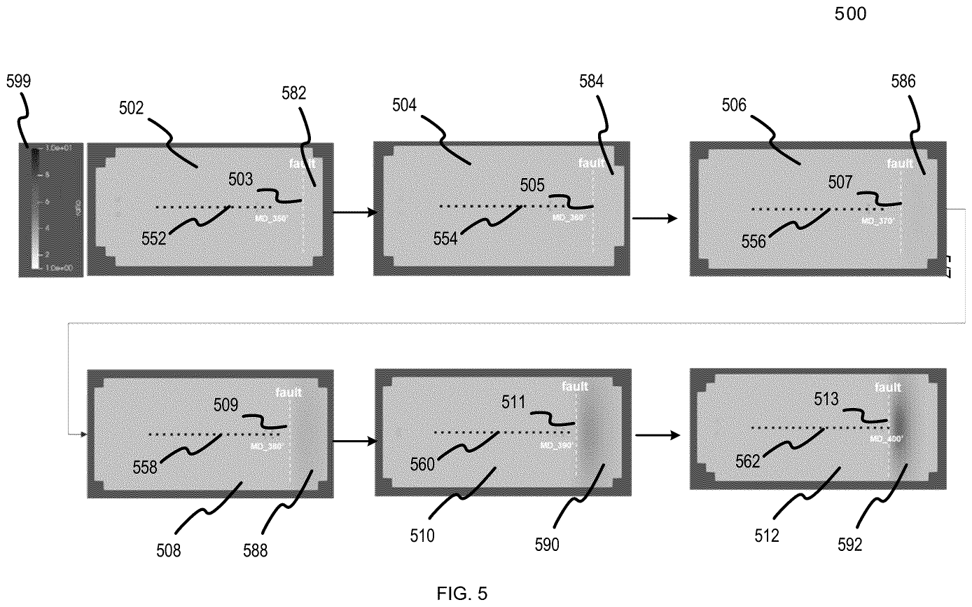

FIG. 5 depicts examples of inverted anisotropy ratios ahead at different depths, according to some implementations. FIG. 5 includes an example 502 at a depth of 350 feet (ft), an example 504 at a depth of 360 ft, an example 506 at a depth of 370 ft, an example 508 at a depth of 380 ft, an example 510 at a depth of 390 ft, and an example 512 at a depth of 400 ft. The examples 502-512 include wellbores 552-562 and faults 503-513, respectively. The examples 502-512 also include areas 582-592 beyond the fault. The darker the areas 582-592 are the greater the anisotropy ratios are. In this example, the range of the anisotropy ratio is from 10 to 1 (as shown by a range 599). The darkest is 10 and the lightest is 1.

The example 512 illustrates where the wellbore 562 is intersecting with the fault 513. In this example, the fault 513 and a change in the type of subsurface formation is easily detected (see the darkness of the area 592). The example 510 illustrates where the wellbore 560 is close to (but not intersecting) the fault 511. In this example, the darkness of the area 590 is lighter than the area 592 but may still be detected.

The example 508 illustrates where the wellbore 558 is farther away from the fault 509 (as compared to the example 510). In this example, the darkness of the area 588 is lighter than the area 590 but may still be detected. The example 506 illustrates where the wellbore 556 is farther away from the fault 507 (as compared to the example 508). In this example, the darkness of the area 586 is lighter than the area 588 but may still be detected. The example 504 illustrates where the wellbore 554 is farther away from the fault 505 (as compared to the example 506). In this example, the area 584 is lighter than the area 586. The example 502 illustrates where the wellbore 552 is farther away from the fault 503 (as compared to the example 504). In this example, the area 582 is lighter than the area 584. Accordingly in these examples of FIG. 5, the detection range (based on the anisotropy ratio is around 30 feet from the fault).

### Example Operations

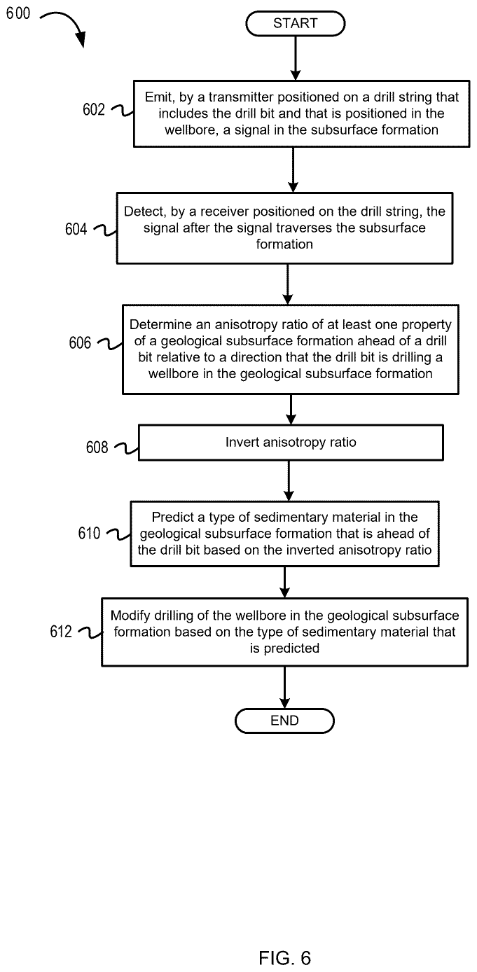

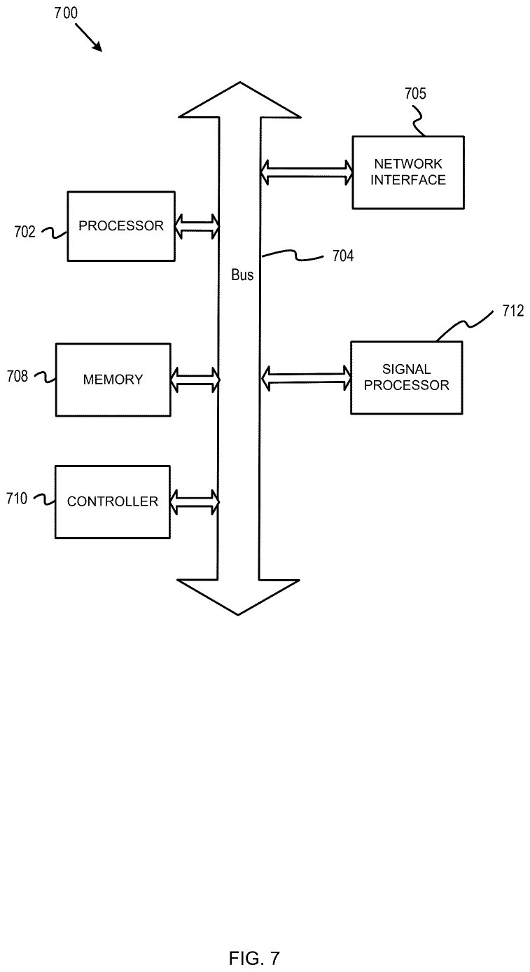

FIG. 6 is a flowchart of example operations for downhole anisotropy inversion for look ahead detection during drilling, according to some implementations. FIG. 6 includes a flowchart 600 that is described in reference to FIGS. 2 and 7. While described in reference to a given number of operations in a given order, operations of the flowchart 600 may have more or less operations and/or in a different order. Operations of the flowchart 600 start at block 602.

At block 602, a transmitter positioned on a drill string that includes the drill bit and that is positioned in the wellbore emits a signal in the subsurface formation. For example, with reference to FIG. 2, the transmitter sub 202 of the downhole tool 200 may emit an electromagnetic signal into the subsurface formation around the wellbore.

At block 604, a receiver positioned on the drill string detects the signal after the signal traverses the subsurface formation. For example, with reference to FIG. 2, at least one of the receiver subs 202 of the downhole tool 200 may detect the electromagnetic signal after the signal traverses the subsurface formation.

At block 606, an anisotropy ratio is determined of at least one property of a geological subsurface formation ahead of a drill bit relative to a direction that the drill bit is drilling a wellbore in the geological subsurface formation. For example, with reference to FIG. 7 (further described below), a signal processor 712 may make this determination.

At block 608, the anisotropy ratio is inverted. For example, with reference to FIG. 7 (further described below), the signal processor 712 may perform this inversion.

At block 610, a type of sedimentary material in the geological subsurface formation that is ahead of the drill bit is predicted based on the inverted anisotropy ratio. For example, with reference to FIG. 7 (further described below), the signal processor 712 may perform this prediction.

At block 612, drilling of the wellbore in the geological subsurface formation is modified based on the type of sedimentary material that is predicted. For example, with reference to FIG. 7 (further described below), a controller 710 may modify the drilling of the wellbore. For instance, the controller 710 may modify a direction of the drilling of the wellbore such that the wellbore stays within a hydrocarbon bearing formation.

### Example Computer

FIG. 7 is a block diagram of an example computer, according to some implementations. FIG. 7 depicts a computer 700 that may be positioned downhole and/or at the surface of the wellbore. The computer 700 may include one or more processors 702 connected to a system bus 704. The system bus 704 may be connected to memory 708 and a network interface 705. The memory 708 may include any suitable memory random access memory (RAM), non-volatile memory (e.g., magnetic memory device), and/or any device for storing information and instructions executable by the processor(s) 702. The network interface 705 may provide connectivity to any suitable network, such as a wired network, wireless network, satellite network, etc.

The computer 700 may include additional peripheral devices. For example, the computer 700 may include multiple external multiple processors. In some implementations, any of the components may be integrated or subdivided. The computer 700 also includes a controller 710 and a signal processor 712. The controller 710 and the signal processor 712 may implement any one or more of the methods and operations described herein. Although the components are shown separately, any of the components of the computer 700 may be further combined or subdivided.

Any component of the computer 700 may be implemented as hardware, firmware, and/or machine-readable media including computer-executable instructions for performing the operations described herein. For example, some implementations include one or more non-transitory machine-readable media including computer-executable instructions including program code configured to perform functionality described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

### Example Implementations

Example implementations are now described.
Implementation #1: A method comprising: determining an anisotropy ratio of at least one property of a subsurface formation ahead of a drill bit relative to a direction that the drill bit is drilling a wellbore in the subsurface formation; inverting the anisotropy ratio; and predicting a formation characteristic of the subsurface formation that is ahead of the drill bit based on the inverted anisotropy ratio.
Implementation #2: The method of Implementation #1, further comprising: emitting, by a transmitter positioned on a drill string that includes the drill bit and that is positioned in the wellbore, a signal in the subsurface formation; and detecting, by a receiver positioned on the drill string, the signal, wherein determining the anisotropy ratio comprises determining the anisotropy ratio based on the signal detected by the receiver.
Implementation #3: The method of Implementation #2, wherein at least one of the transmitter or the receiver comprises a magnetic coil and wherein the signal comprises an electromagnetic signal.
Implementation #4: The method of Implementation #2, wherein the at least one property comprises a resistivity.
Implementation #5: The method of Implementation #4, wherein determining the anisotropy ratio comprises determining a ratio of a horizontal resistivity to a vertical resistivity of the subsurface formation.
Implementation #6: The method of Implementations #4-5, further comprising: modifying drilling of the wellbore in the subsurface formation based on a type of sedimentary material that is predicted.
Implementation #7: The method of Implementation #6, wherein modifying drilling of the wellbore comprises changing a direction of the drilling of the wellbore or stopping the drilling.
Implementation #8: The method of any one of Implementations #1-7, wherein the formation characteristic comprises a type of sedimentary material.
Implementation #9: The method of any one of Implementations #1-8, wherein predicting a type of sedimentary material comprises predicting whether the sedimentary material is a shale-based formation, or a sand or water-bearing formation.
Implementation #10: The method of any one of Implementations #1-9, wherein the wellbore is approximately horizontal ahead of the drill bit.
Implementation #11: A system comprising: a transmitter, that is part of a bottomhole assembly of a drill string that includes a drill bit and that is to be positioned in a wellbore formed in a subsurface formation, configured to emit an electromagnetic signal into the subsurface formation; a receiver, that is part of the bottomhole assembly, configured to receive the electromagnetic signal after the electromagnetic signal traverses the subsurface formation; a processor; and a machine-readable media including computer-executable instructions that cause the processor to perform operations, the instructions comprising, instructions to determine, based on the electromagnetic signal received by the receiver, an anisotropy ratio of at least one property of the subsurface formation ahead of the drill bit relative to a direction that the drill bit is drilling the wellbore in the subsurface formation; instructions to invert the anisotropy ratio; and instructions to predict a formation characteristic of the subsurface formation that is ahead of the drill bit based on the inverted anisotropy ratio.
Implementation #12: The system of Implementation #11, wherein the at least one property comprises a resistivity.
Implementation #13: The system of Implementation #12, wherein the instructions to determine the anisotropy ratio comprise instructions to determine a ratio of a horizontal resistivity to a vertical resistivity of the subsurface formation.
Implementation #14: The system of any one of Implementations #11-13, wherein the instructions comprise: instructions to modify drilling of the wellbore in the subsurface formation based on a type of formation characteristic that is predicted.
Implementation #15: The system of any one of Implementations #11-14, wherein the formation characteristic comprises a type of sedimentary material, and wherein the instructions to predict comprise instructions to predict whether the sedimentary material is a shale-based formation, or a sand or water-bearing formation.
Implementation #16: One or more machine-readable media including computer-executable instructions that cause one or more processors to perform operations, the instructions comprising: instructions to determine an anisotropy ratio of at least one property of a subsurface formation ahead of a drill bit relative to a direction that the drill bit is drilling a wellbore in the subsurface formation; instructions to invert the anisotropy ratio; and instructions to predict a formation characteristic of the subsurface formation that is ahead of the drill bit based on the inverted anisotropy ratio.
Implementation #17: The one or more machine-readable media of Implementation #16, wherein the at least one property comprises a resistivity.
Implementation #18: The one or more machine-readable media of Implementations #16 or 17, wherein the instructions to determine the anisotropy ratio comprise instructions to determine a ratio of a horizontal resistivity to a vertical resistivity of the subsurface formation.
Implementation #19: The one or more machine-readable media of any one of Implementations #16-18, wherein the instructions comprise: instructions to modify drilling of the wellbore in the subsurface formation based on a type of formation characteristic that is predicted.
Implementation #20: The one or more machine-readable media of any one of Implementations #16-19, wherein the wellbore is approximately horizontal ahead of the drill bit.

1. A method comprising:
determining an anisotropy ratio of at least one property of a subsurface formation ahead of a drill bit relative to a direction that the drill bit is drilling a wellbore in the subsurface formation;
inverting the anisotropy ratio; and
predicting a formation characteristic of the subsurface formation that is ahead of the drill bit based on the inverted anisotropy ratio.

2. The method of claim 1, further comprising:
emitting, by a transmitter positioned on a drill string that includes the drill bit and that is positioned in the wellbore, a signal in the subsurface formation; and
detecting, by a receiver positioned on the drill string, the signal, wherein determining the anisotropy ratio comprises determining the anisotropy ratio based on the signal detected by the receiver.

3. The method of claim 2, wherein at least one of the transmitter or the receiver comprises a magnetic coil and wherein the signal comprises an electromagnetic signal.

4. The method of claim 2, wherein the at least one property comprises a resistivity.

5. The method of claim 4, wherein determining the anisotropy ratio comprises determining a ratio of a horizontal resistivity to a vertical resistivity of the subsurface formation.

6. The method of claim 4, further comprising:
modifying drilling of the wellbore in the subsurface formation based on a type of sedimentary material that is predicted.

7. The method of claim 6, wherein modifying drilling of the wellbore comprises changing a direction of the drilling of the wellbore or stopping the drilling.

8. The method of claim 1, wherein the formation characteristic comprises a type of sedimentary material.

9. The method of claim 1, wherein predicting a type of sedimentary material comprises predicting whether the sedimentary material is a shale-based formation, or a sand or water-bearing formation.

10. The method of claim 1, wherein the wellbore is approximately horizontal ahead of the drill bit.

11. A system comprising:
a transmitter, that is part of a bottomhole assembly of a drill string that includes a drill bit and that is to be positioned in a wellbore formed in a subsurface formation, configured to emit an electromagnetic signal into the subsurface formation;
a receiver, that is part of the bottomhole assembly, configured to receive the electromagnetic signal after the electromagnetic signal traverses the subsurface formation;
a processor; and
a non-transitory machine-readable media including computer-executable instructions that cause the processor to perform operations, the instructions comprising,
instructions to determine, based on the electromagnetic signal received by the receiver, an anisotropy ratio of at least one property of the subsurface formation ahead of the drill bit relative to a direction that the drill bit is drilling the wellbore in the subsurface formation;
instructions to invert the anisotropy ratio; and
instructions to predict a formation characteristic of the subsurface formation that is ahead of the drill bit based on the inverted anisotropy ratio.

12. The system of claim 11, wherein the at least one property comprises a resistivity.

13. The system of claim 12, wherein the instructions to determine the anisotropy ratio comprise instructions to determine a ratio of a horizontal resistivity to a vertical resistivity of the subsurface formation.

14. The system of claim 11, wherein the instructions comprise:
instructions to modify drilling of the wellbore in the subsurface formation based on a type of formation characteristic that is predicted.

15. The system of claim 11,
wherein the formation characteristic comprises a type of sedimentary material, and
wherein the instructions to predict comprise instructions to predict whether the sedimentary material is a shale-based formation, or a sand or water-bearing formation.

16. One or more non-transitory machine-readable media including computer-executable instructions that cause one or more processors to perform operations, the instructions comprising:
instructions to determine an anisotropy ratio of at least one property of a subsurface formation ahead of a drill bit relative to a direction that the drill bit is drilling a wellbore in the subsurface formation;
instructions to invert the anisotropy ratio; and
instructions to predict a formation characteristic of the subsurface formation that is ahead of the drill bit based on the inverted anisotropy ratio.

17. The one or more non-transitory machine-readable media of claim 16, wherein the at least one property comprises a resistivity.

18. The one or more non-transitory machine-readable media of claim 16, wherein the instructions to determine the anisotropy ratio comprise instructions to determine a ratio of a horizontal resistivity to a vertical resistivity of the subsurface formation.

19. The one or more non-transitory machine-readable media of claim 16, wherein the instructions comprise:
instructions to modify drilling of the wellbore in the subsurface formation based on a type of formation characteristic that is predicted.

20. The one or more non-transitory machine-readable media of claim 16, wherein the wellbore is approximately horizontal ahead of the drill bit.
